(19) United States
(12) Patent Application Publication
(10) Pub. No.: US 2020/0219028 A1
(43) Pub. Date: Jul. 9, 2020

(54) SYSTEMS, METHODS, AND MEDIA FOR DISTRIBUTING DATABASE QUERIES ACROSS A METERED VIRTUAL NETWORK

(71) Applicant: BRANDEIS UNIVERSITY, Waltham, MA (US)

(72) Inventors: Olga Papaemmanouil, Waltham, MA (US); Ryan Marcus, Los Alamos, NM (US)

(21) Appl. No.: 16/643,779

(22) PCT Filed: Sep. 5, 2018
(86) PCT No.: PCT/US18/49553

§ 371 Date: Mar. 2, 2020

Related U.S. Application Data
(60) Provisional application No. 62/554,514, filed on Sep. 5, 2017.

(51) Int. Cl. G06Q 10/06; G06F 16/27; G06F 16/2458; G06F 9/455; G06Q 30/02; G06Q 20/14; G06N 7/00

(52) U.S. Cl. CPC G06Q 10/06312; G06F 16/27; G06F 16/2471; G06F 9/45558; G06F 2009/4557; G06Q 10/06375; G06Q 20/145; G06N 7/005; G06Q 30/0206

(57) ABSTRACT

Methods, systems, and media for distributing database queries across a metered virtual network are provided, the method comprising: receiving a first query at a first time; selecting, using probabilistic models, a first virtual machine to execute the first query, each of the probabilistic models associated with one of a plurality of virtual machines; receiving information indicative of a monetary cost of executing the first query based at least in part on the execution time of the first query by the first virtual machine; providing an observation to each of the plurality of probabilistic models, wherein the observation includes at least information about the cost of executing the first query, and information about an action selected by the probabilistic model in connection with the first query; and reducing, over time, the costs of using the metered virtual network to execute queries received after the first query based on the observations.

### CROSS-REFERENCE TO RELATED APPLICATIONS

This application is based on, claims the benefit of, and claims priority to U.S. Provisional Application No. 62/554,514, filed Sep. 5, 2017, which is hereby incorporated herein by reference in its entirety for all purposes.

### STATEMENT REGARDING FEDERALLY SPONSORED RESEARCH

This invention was made with government support under U.S. Pat. No. 1,253,196 awarded by the National Science Foundation. The government has certain rights in the invention.

### BACKGROUND

Infrastructure-as-a-Service (IaaS) providers offer low cost and on-demand computing and storage resources, allowing applications to dynamically provision resources by procuring and releasing them depending on the requirements of incoming workloads. Compared with traditional datacenters, this approach allows applications to avoid static over provisioned, or under provisioned, systems by scaling up or down for spikes, or decreases, in demand. This is realized by a “pay as you go” model of these services cloud, in which applications pay only for the resources used and only for as long as they are used.

However, taking advantage of these benefits remains a complex task for data management applications, as deploying and scaling an application on an IaaS cloud requires making a myriad of resource and workload decisions. Typically, developers must make decisions about how many machines to provision, which queries to route to which machines, and how to schedule queries within machines. Minimizing (or even predicting) the cost of each of these decisions is a complex task, as the resource availability of each machine and the execution order of the queries within them have great impact on the execution time of query workloads. This complexity increases significantly if applications are intended to meet certain performance goals (e.g., Service-Level-Objectives/SLOs).

Most IaaS providers leave it to users to manually instigate a scaling action when their application becomes popular or during periods of decreased demand, and allow users to deploy custom strategies for dispatching workloads to reserved machines. Therefore, in many real-world applications, scaling and workload distributions decisions are made based on rules-of-thumb, gut instinct, or, sometimes, even past data. Even when application developers grasp the complexity of cloud offerings, it is often still difficult to translate an application's performance goal (e.g., queries must complete within 5 minutes, or the average latency must be less than 10 minutes) into a cost effective resource configuration and workload distribution solution.

Many previously proposed workload and resource management solutions are not end-to-end. Rather, they typically address only one issue, such as query routing to a reserved machine, scheduling within a single machine, or provisioning machines, without addressing the others. However, applications must address all of these challenges, and integrating separate solutions for each problem is extremely difficult due to different assumptions made by each individual technique. More importantly, even solutions that span several of the decisions that must be made by cloud applications depend on a query latency prediction model, which is problematic for two reasons. First, many latency prediction models depend on seeing each “query template” beforehand in a training phase, leading to poor predictions on previously-unseen queries. Second, accurate query latency prediction is very challenging. State-of-the-art results for predicting the performance of concurrent queries executed on a single node achieve 85% accuracy for known query types and 75% accuracy for previously unseen queries. A cloud setting only brings about additional complications like “noisy neighbors” and requires training these models on virtual machines with vastly different underlying resource configurations.

Status quo solutions, such as scaling based on rules-of-thumb, human-triggered events or techniques that rely on a query performance prediction models, fail to fully achieve the promise of IaaS-deployed cloud databases. Humans may be drastically incorrect or inaccurate when attempting to predict the best times to scale and what scale to use. Latency prediction-based techniques suffer from a large range of accuracy problems that worsen with scale and unknown query types, inherently undermining the main objective: estimating the cost of using cloud resources while meeting performance goals.

Accordingly, systems, methods, and media for distributing database queries across a metered virtual network are desirable.

### SUMMARY

In accordance with some embodiments of the disclosed subject matter, systems, methods, and media for distributing database queries across a metered virtual network are provided.

In accordance with some embodiments of the disclosed subject matter, a method for distributing database queries across a metered virtual network is provided, the method comprising: receiving a first query at a first time; selecting, using a plurality of probabilistic models, a first virtual machine of a plurality of virtual machines provided via the metered virtual network to execute the first query, wherein each of the plurality of probabilistic models is associated with one of the plurality of virtual machines; receiving information indicative of a monetary cost of executing the first query using the first virtual machine, wherein the cost is based at least in part on the execution time of the first query by the first virtual machine; providing an observation to each of the plurality of probabilistic models, wherein the observation includes at least information about the cost of executing the first query, and information about an action selected by the probabilistic model in connection with the first query; and reducing, over time, the costs of using the metered virtual network to execute queries that are received after the first query based on the observations.

In some embodiments, the method further comprises: determining a context based at least in part on the query and based on a state of first virtual machine at the first time; and providing the context to a first probabilistic model of the plurality of probabilistic models that is associated with the first virtual machine as a feature vector.

In some embodiments, the method further comprises: predicting, using the first probabilistic model, the monetary cost of the first virtual machine executing the query based on the context; and predicting, using the first probabilistic model, the monetary cost of passing the query to a second virtual machine of the plurality of virtual machines.

In some embodiments, the method further comprises selecting the first virtual machine to execute the query based on the predicted cost of the first virtual machine executing the query being lower than the predicted cost of passing the query to the second virtual machine.

In some embodiments, the first virtual machine and the second virtual machine are part of a group of virtual machines that have a particular configuration.

In some embodiments, the first virtual machine is part of a first group of virtual machines that have a first particular configuration, and the second virtual machine has a second particular configuration that is different than the first particular configuration.

In some embodiments, the method further comprises selecting to pass the query to the second first virtual machine based on the predicted cost of passing the query to the second virtual machine being lower than the predicted cost of the first virtual machine executing the query.

In some embodiments, the method further comprises: determining that the second virtual machine does not currently exist; and in response to determining that the second virtual machine does not currently exist, causing a computing service to launch the second virtual machine.

In some embodiments, each of the plurality of probabilistic models is associated with an experience set, and the method further comprises: adding to the experience set, for each of the plurality of probabilistic models, a context based on the query and based on a state of that probabilistic model at the first time, an action taken by that probabilistic model in connection with the query, and a cost associated with execution of the query by the first virtual machine.

In some embodiments, the plurality of probabilistic models are organized into hierarchical tiers with virtual machines associated with probabilistic models in a particular tier having a common configuration, and each of the plurality of probabilistic models is a contextual multi-armed bandit (CMAB)-based reinforcement learning model that is configured to evaluate which action of a group of actions to select in connection with a particular query, the group of actions including: accepting the particular query; passing the particular query to a next probabilistic model in the same tier; and passing the particular query to a next tier.

In accordance with some embodiments of the disclosed subject matter, a system for distributing database queries across a metered virtual network is provided, the system comprising: at least one hardware processor; and memory storing instructions that, when executed, cause the at least one hardware processor to: receive a first query at a first time; select, using a plurality of probabilistic models, a first virtual machine of a plurality of virtual machines provided via the metered virtual network to execute the first query, wherein each of the plurality of probabilistic models is associated with one of the plurality of virtual machines; receive information indicative of a monetary cost of executing the first query using the first virtual machine, wherein the cost is based at least in part on the execution time of the first query by the first virtual machine; provide an observation to each of the plurality of probabilistic models, wherein the observation includes at least information about the cost of executing the first query, and information about an action selected by the probabilistic model in connection with the first query; and reduce, over time, the costs of using the metered virtual network to execute queries that are received after the first query based on the observations.

In accordance with some embodiments, a non-transitory computer readable medium containing computer executable instructions that, when executed by a processor, cause the processor to perform a method for distributing database queries across a metered virtual network is provided, the method comprising: receiving a first query at a first time; selecting, using a plurality of probabilistic models, a first virtual machine of a plurality of virtual machines provided via the metered virtual network to execute the first query, wherein each of the plurality of probabilistic models is associated with one of the plurality of virtual machines; receiving information indicative of a monetary cost of executing the first query using the first virtual machine, wherein the cost is based at least in part on the execution time of the first query by the first virtual machine; providing an observation to each of the plurality of probabilistic models, wherein the observation includes at least information about the cost of executing the first query, and information about an action selected by the probabilistic model in connection with the first query; and reducing, over time, the costs of using the metered virtual network to execute queries that are received after the first query based on the observations.

### BRIEF DESCRIPTION OF THE DRAWINGS

Various objects, features, and advantages of the disclosed subject matter can be more fully appreciated with reference to the following detailed description of the disclosed subject matter when considered in connection with the following drawings, in which like reference numerals identify like elements.

FIG. 1 shows an example of a system for distributing database queries across a metered virtual network in accordance with some embodiments of the disclosed subject matter.

FIG. 2 shows an example of hardware that can be used to implement a computing service and a computing device in accordance with some embodiments of the disclosed subject matter.

FIG. 3 shows an example of a system for modeling the cost of queries using reinforcement learning techniques in accordance with some embodiments of the disclosed subject matter.

FIG. 4 shows an example of tiered models that can select a particular virtual machine to perform an incoming query in accordance with some embodiments of the disclosed subject matter.

FIG. 5 shows an example of a process for distributing database queries across a metered virtual network in accordance with some embodiments of the disclosed subject matter.

FIG. 6 shows examples of representative results of tests measuring the effectiveness of techniques described herein in accordance with some embodiments of the disclosed subject matter

FIGS. 7A and 7B show additional examples of representative results of tests measuring the effectiveness of techniques described herein in accordance with some embodiments of the disclosed subject matter.

FIG. 8 shows yet another example of representative results of tests measuring the effectiveness of techniques described herein in accordance with some embodiments of the disclosed subject matter.

### DETAILED DESCRIPTION

In accordance with various embodiments, mechanisms (which can, for example, include systems, methods, and media) for distributing database queries across a metered virtual network are provided.

In some embodiments, the mechanisms described herein can interact with a metered compute service to deploy virtual machines for executing database queries, and can distribute incoming queries based on models of the expected cost of executing the query using a particular virtual machine. For example, the mechanisms described herein can automatically control deployment of resources by an Infrastructure-as-a-Service (IaaS) provider that offers on-demand computing and/or storage resources and charges only for resources that are actually being used by a particular application. In some embodiments, the mechanisms described herein can accept performance goals and can generate models that account for the performance goals. In some embodiments, the mechanisms described herein can adapt and continuously learn from shifts in query workloads to attempt to maintain relatively low-cost deployments. In some embodiments, the mechanisms described herein can automatically scale resources and distribute incoming query workloads based on models that account for the cost of deploying resources (e.g., through an IaaS provider) and the cost of failing to meet performance goals. In some embodiments, the mechanisms described herein can build models of the cost of various actions, which can implicitly capture query latency information without explicitly modeling query latency (which can be very problematic in a cloud setting). In some embodiments, the mechanisms described herein can balance exploration of different strategies and exploitation of learned low-cost strategies by automatically using new resource configurations and taking advantage of prior knowledge.

In some embodiments, the mechanisms described herein can utilize reinforcement learning techniques to learn (and over time improve) cost-effective performance management policies that take into account application-defined service-level objectives (SLOs). In some embodiments, the mechanisms described herein can generate models that learn relationships between workload management decisions and the monetary cost of such decisions. These models can be used to automatically scale up and down the pool of reserved virtual machines and make decisions about the processing sites of incoming queries without incorporating prior knowledge of the incoming workloads (e.g., templates, tables, latency estimates). This can relieve developers from performing tasks such as tasks of system scaling, query routing, and scheduling, and/or developing rules for performing these tasks based on intuition or rules of thumb. In some embodiments, the mechanisms described herein can use machine learning techniques to produce systems that adapt to changes in query arrival rates and dynamic resource configurations, while handling diverse application-defined performance goals, and without relying on any performance prediction model.

In some embodiments, the mechanisms described herein can be situated between the IaaS provider and a data management application that submits queries and/or SLOs. In some embodiments, the mechanisms described herein can be implemented using an application that is deployed on an IaaS cloud and/or otherwise has full control of provisioning virtual machines and distributing incoming queries across the deployed virtual machines.

In some embodiments, the mechanisms described herein can deploy each reserved virtual machine with a full replica of a database or partitioned tables of the database (where each partition can also be replicated). Additionally, in some embodiments, the mechanisms described herein can account for SLOs promised to end-users of the database, and if the SLO is not met, the mechanisms can use a penalty function that defines the monetary cost of the violation when using a decision that led to a violation of an SLO to generate models corresponding to the various virtual machines.

In some embodiments, queries can be received by the mechanisms described herein one at a time with an unknown arrival rate, and the mechanisms can schedule execution of the query by an existing virtual machine or a newly provisioned virtual machine. In some embodiments, the received queries can be instances of query templates (e.g., TPC-H), but the templates can be unknown and not used in making scheduling decisions. In some embodiments, the mechanisms described herein can attempt to minimize the monetary cost of executing the incoming queries, which can include the cost for maintaining deployed virtual machines, and the cost of any SLO violation fees. For example, each virtual machine can cost a fixed dollar amount for a given period of operation, and virtual machines of different types (e.g., with different resource configurations) can be offered at different costs.

In some embodiments, the mechanisms described herein can define (or receive a definition of) an SLO, and a penalty function that specifies the monetary cost of failing to achieve the SLO. Such SLOs can define the performance expected on each query and/or the performance of the system on average (on the workload level). For example, an SLO can define a deadline for completing each incoming query. As another example, an SLO can define an upper bound on the maximum or average latency of the submitted queries. As yet another example, an SLO can define a deadline on a percentile of the queries within a specific time period. In a more particular example, an SLO can require that 99% of submitted queries received each hour must complete within five minutes. In some embodiments, if an SLO is defined over a set of queries, the mechanisms described herein can aim to minimize the cumulative cost of executing the set of queries.

In some embodiments, the mechanisms described herein can receive incoming queries, select a virtual machine to execute the query, submit the query to the selected virtual machine, and return the results. In some embodiments, the mechanisms described herein can interact with the IaaS provider to provision virtual machines, and submit the queries to selected virtual machines for execution. In some embodiments, the mechanisms described herein can use any suitable technique or combination of techniques to select a virtual machine to be used to execute a query. For example, the mechanisms can use context-aware reinforcement learning techniques that use features of the query and information about the virtual machines that are deployed (and/or that can be deployed) to select a virtual machine to process each new query. In such an example, the virtual machine that is selected may need to be provisioned (e.g., because it is not currently being executed by the IaaS provider). Further, in some embodiments, the mechanisms described herein can determine whether each virtual machine that is currently deployed should be released (e.g., because it would be less costly than continuing to pay for the virtual machine if it is not being assigned many queries). In some embodiments, features of a query are sometimes referred to herein as the context of the decision made with respect to that query. The mechanisms can record the cost of each past decision and the context correlated with that decision into a set of observation data. In some embodiments, by continuously collecting and using past observations, the mechanisms can make improved decisions over time, and can converge to a model that balances the number and types of virtual machines provisioned against any penalty fees, which can facilitate selection of relatively low-cost performance management decisions for each incoming query.

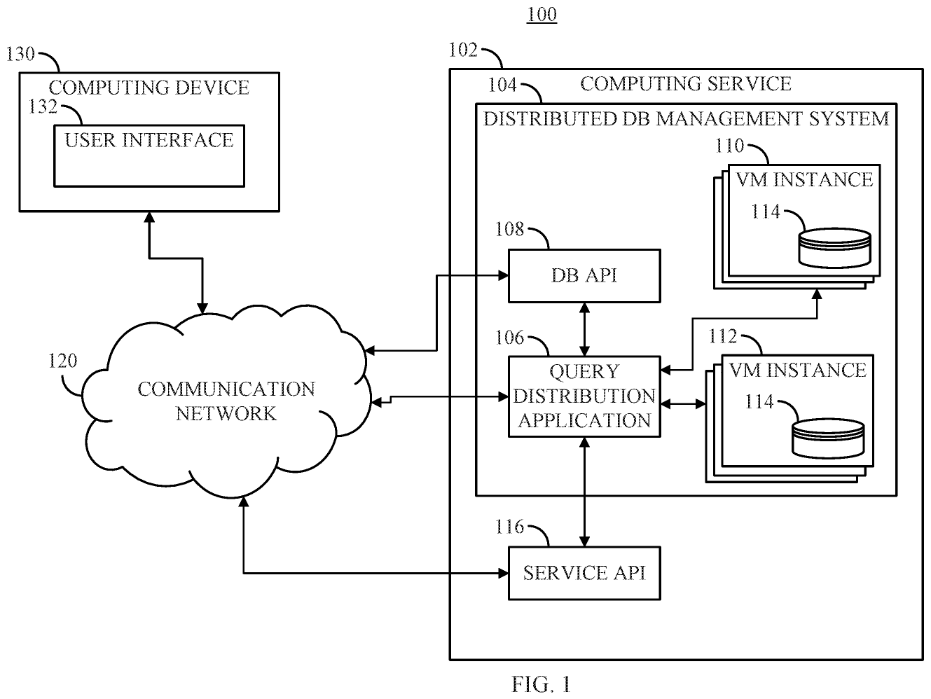

Turning to FIG. 1, an example 100 of a system for distributing database queries across a metered virtual network is shown in accordance with some embodiments of the disclosed subject matter. As shown in FIG. 1, a computing service 102 (e.g., an IaaS provider) can execute one or more applications to provide a distributed database management system 104 that can include, for example, one or more virtual machines that can execute database queries. In some embodiments, distributed database management system 104 can include a query distribution application 106 that can receive one or more queries, and can select a virtual machine to execute the query. Additionally, in some embodiments, query distribution application 106 can receive information about costs associated with computing service 102 and/or distributed database management system 104. For example, query distribution application 106 can receive information about the costs of launching and/or maintaining different types of virtual machines using computing service 102. As another example, query distribution application 106 can receive information about one or more SLOs associated with distributed database management system 104 and/or costs associated with violating each SLO.

In some embodiments, query distribution application 106 can receive information through a database application program interface (API) 108 that can interface with other computing devices to receive queries, receive cost information, receive information about SLOs, etc. For example, DB API 108 can provide a web service that can receive information over a communication network, and can evaluate the information to determine whether it corresponds to a valid API call, whether the user submitting the API call is an authorized user, etc. Additionally or alternatively, query distribution application 106 can receive such information directly without the information first being sent to DB API 108. Note that, in some embodiments, query distribution application 106 and/or DB API 108 can be implemented using virtual machines provided by computing service 102.

In some embodiments, distributed database management system 104 can include various virtual machine machines 110, 112. Virtual machines 110 can have similar configurations, and virtual machines 112 can be configured differently than virtual machines 110 while having similar configurations with each other. For example, virtual machines 110 can be configured with the same processing power, the same amount of memory, the same amount of storage, etc., while virtual machines 112 can have more processing power, more memory and/or more storage. In some embodiments, each virtual machine 110, 112 can be associated with at least a portion of a database 114, which can be used to return results of a query submitted to distributed database management system 104.

In some embodiments, computing service 102 can be associated with a service API 116 that can be called to launch or release virtual machines using various API calls, among other things. For example, if query distribution application 106 selects a new virtual machine to execute a particular query, query distribution application 106 can send an API call to service API 116 with instructions to launch such a virtual machine within distributed database management system 104. In such an example, parameters sent with the API call can indicate the properties of the virtual machine to be launched (e.g., whether it is to be a virtual machine similar to virtual machines 110 or virtual machines 112).

In some embodiments, query distribution application 106 and/or DB API 108 can receive queries, costs, etc., over a communication network 120. In some embodiments, such information can be received from any suitable computing device, such as computing device 130. Additionally or alternatively, in some embodiments, the query can be received via a user interface 132 presented by computing device 130 and/or distributed database management system 104. For example, the query can be received via a web page displayed on computing device 130 and presented by DB API 108 acting as a web server. As another example, the query can be received via an application being executed by computing device 130, and provided to DB API 108 and/or query distribution application 106. In some embodiments, the query submitted to the database management system 104 can be in any suitable format, such as structured query language (SQL).

In some embodiments, communication network 120 can be any suitable communication network or combination of communication networks. For example, communication network 120 can include a Wi-Fi network (which can include one or more wireless routers, one or more switches, etc.), a peer-to-peer network (e.g., a Bluetooth network), a cellular network (e.g., a 3G network, a 4G network, etc., complying with any suitable standard, such as CDMA, GSM, LTE, LTE Advanced, WiMAX, etc.), a wired network, etc. In some embodiments, communication network 120 can be a local area network, a wide area network, a public network (e.g., the Internet), a private or semi-private network (e.g., a corporate or university intranet), any other suitable type of network, or any suitable combination of networks. Communications links shown in FIG. 1 can each be any suitable communications link or combination of communications links, such as wired links, fiber optic links, Wi-Fi links, Bluetooth links, cellular links, etc. In some embodiments, computing service 102 and/or computing device 130 can be any suitable computing device or combination of devices, such as a desktop computer, a laptop computer, a smartphone, a tablet computer, a wearable computer, a server computer, a virtual machine being executed by a physical computing device, etc.

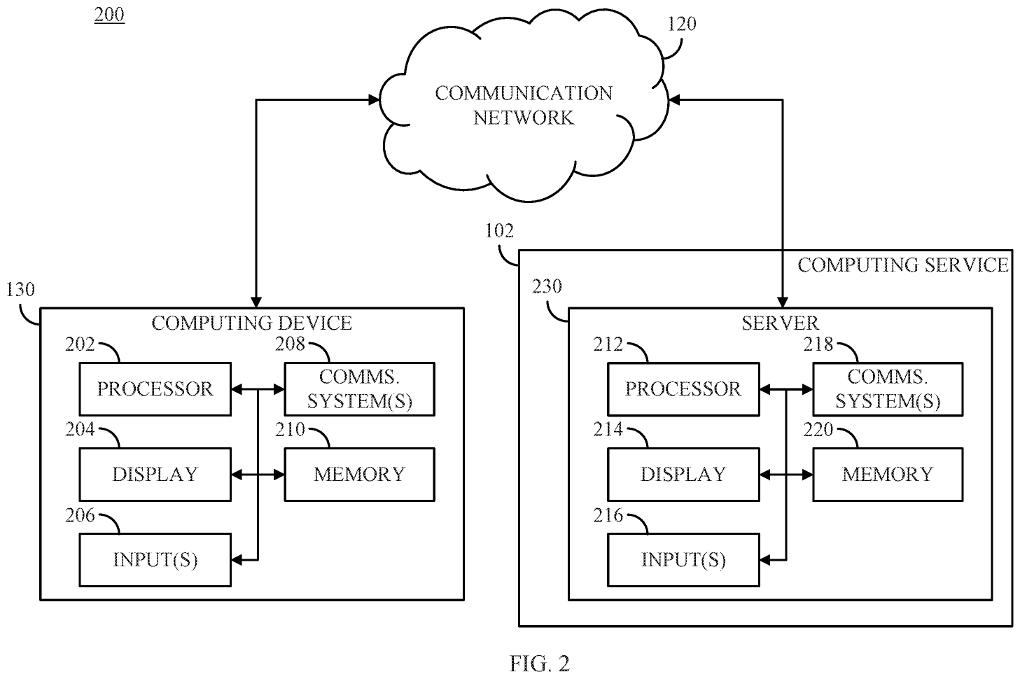

FIG. 2 shows an example 200 of hardware that can be used to implement computing service 102 and computing device 130 in accordance with some embodiments of the disclosed subject matter. As shown in FIG. 2, in some embodiments, computing device 130 can include a processor 202, a display 204, one or more inputs 206, one or more communication systems 208, and/or memory 210. In some embodiments, processor 202 can be any suitable hardware processor or combination of processors, such as a central processing unit, a graphics processing unit, etc. In some embodiments, display 204 can include any suitable display devices, such as a computer monitor, a touchscreen, a television, etc. In some embodiments, inputs 206 can include any suitable input devices and/or sensors that can be used to receive user input, such as a keyboard, a mouse, a touchscreen, a microphone, etc.

In some embodiments, communications systems 208 can include any suitable hardware, firmware, and/or software for communicating information over communication network 120 and/or any other suitable communication networks. For example, communications systems 208 can include one or more transceivers, one or more communication chips and/or chip sets, etc. In a more particular example, communications systems 208 can include hardware, firmware and/or software that can be used to establish a Wi-Fi connection, a Bluetooth connection, a cellular connection, an Ethernet connection, etc.

In some embodiments, memory 210 can include any suitable storage device or devices that can be used to store instructions, values, etc., that can be used, for example, by processor 202 to present content using display 204, to communicate with server 120 via communications system(s) 208, etc. Memory 210 can include any suitable volatile memory, non-volatile memory, storage, or any suitable combination thereof. For example, memory 210 can include RAM, ROM, EEPROM, one or more flash drives, one or more hard disks, one or more solid state drives, one or more optical drives, etc. In some embodiments, memory 210 can have encoded thereon a computer program for controlling operation of computing device 130. In such embodiments, processor 202 can execute at least a portion of the computer program to present content (e.g., user interfaces, tables, graphics, etc.), receive content from computing service 102, transmit information to computing service 102, etc.

In some embodiments, computing service 102 can be implemented using one or more servers 230 that can include a processor 212, a display 214, one or more inputs 216, one or more communications systems 218, and/or memory 220. In some embodiments, processor 212 can be any suitable hardware processor or combination of processors, such as a central processing unit, a graphics processing unit, etc. In some embodiments, display 214 can include any suitable display devices, such as a computer monitor, a touchscreen, a television, etc. In some embodiments, inputs 216 can include any suitable input devices and/or sensors that can be used to receive user input, such as a keyboard, a mouse, a touchscreen, a microphone, etc.

In some embodiments, communications systems 218 can include any suitable hardware, firmware, and/or software for communicating information over communication network 120 and/or any other suitable communication networks. For example, communications systems 218 can include one or more transceivers, one or more communication chips and/or chip sets, etc. In a more particular example, communications systems 218 can include hardware, firmware and/or software that can be used to establish a Wi-Fi connection, a Bluetooth connection, a cellular connection, an Ethernet connection, etc.

In some embodiments, memory 220 can include any suitable storage device or devices that can be used to store instructions, values, etc., that can be used, for example, by processor 212 to present content using display 214, to communicate with one or more computing devices 130, etc. Memory 220 can include any suitable volatile memory, non-volatile memory, storage, or any suitable combination thereof. For example, memory 220 can include RAM, ROM, EEPROM, one or more flash drives, one or more hard disks, one or more solid state drives, one or more optical drives, etc. In some embodiments, memory 220 can have encoded thereon a server program for controlling operation of server 230. In such embodiments, processor 212 can execute at least a portion of the server program to transmit information and/or content (e.g., results of a database query, a user interface, etc.) to one or more computing 130, receive information and/or content from one or more computing devices 130, receive instructions from one or more devices (e.g., a personal computer, a laptop computer, a tablet computer, a smartphone, etc.), etc.

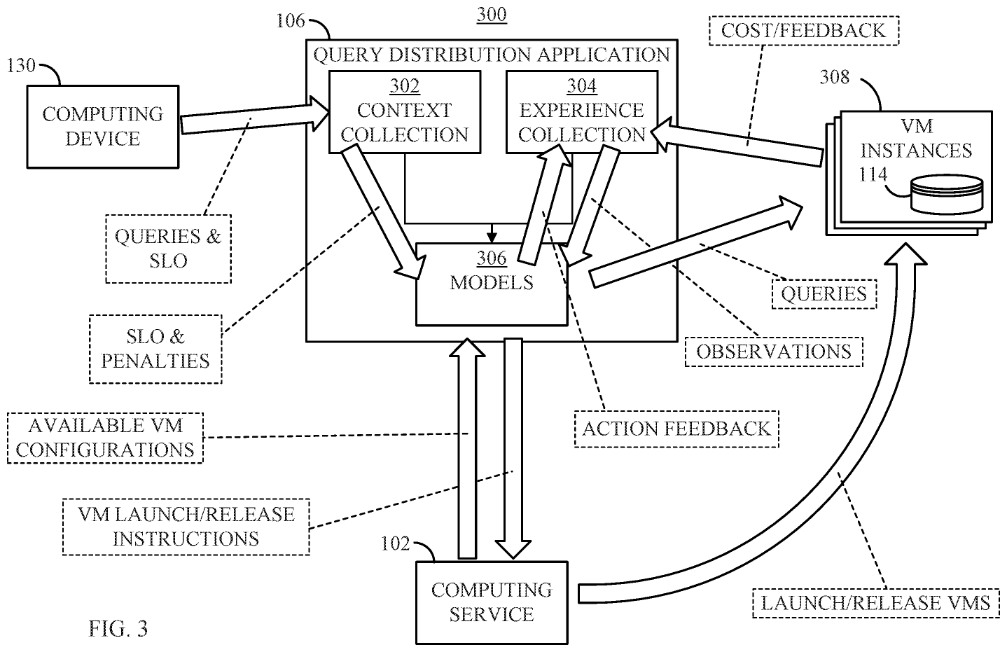

FIG. 3 shows an example 300 of a system for modeling the cost of queries using reinforcement learning techniques in accordance with some embodiments of the disclosed subject matter. As shown in FIG. 3, query distribution application 106 can include various components, such as a context collection component 302 (sometimes referred to herein as a collector), an experience collection component 304 (sometimes referred to herein as an experience collector), and a modeling component 306 (sometimes referred to herein as a model generator). In some embodiments, query collector 302 can receive information about the queries being submitted (e.g., from computing device 130), and SLOs that are expected to be met. For example, query collector 302 can receive information about a query, and can generate information about the received query that can be used by model generator 306 to learn about which queries are advantageously sent to a particular virtual machine. As another example, query collector 302 can receive information about SLOs and the cost (e.g., penalty) for violating the SLOs. In such an example, query collector 302 can pass information about the SLO and/or cost of violating the SLO to model generator 306 for use in evaluating the cost of actions taken by a model corresponding to each virtual machine.

In some embodiments, experience collector 304 can receive information about the cost of executing a particular query and the state of the various virtual machines (e.g., virtual machines 308) when the query arrived from virtual machines 308 (and/or computing service 102). For example, experience collector can receive the time it took to execute the query. As another example, experience collector can receive information about how many virtual machines are currently being executed at the time the query is received and/or how many of each type of virtual machine is being executed.

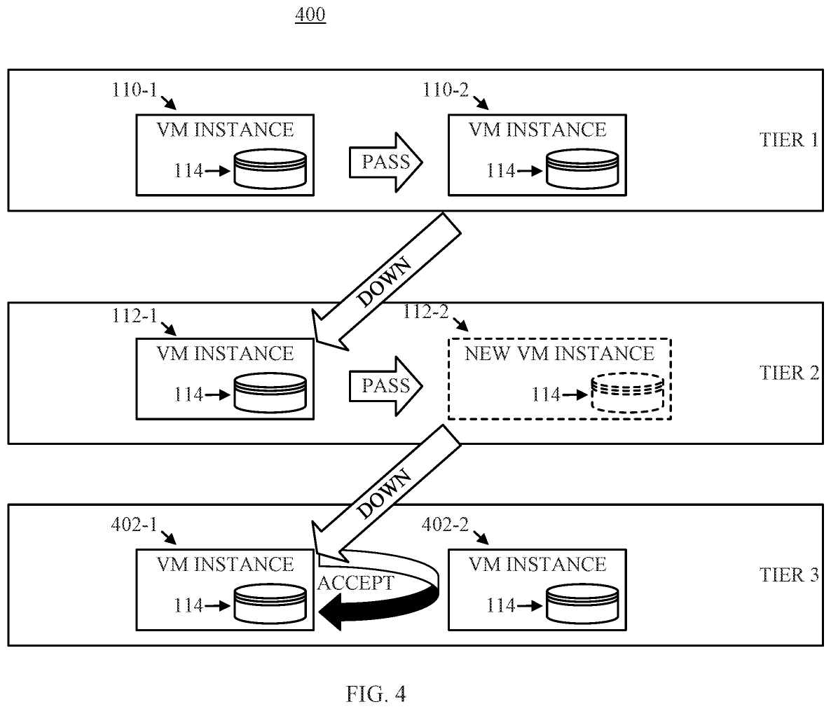

In some embodiments, model generator 306 can receive information about which virtual machine configurations are available (e.g., from computing service 102), and observations about past actions taken by each model. As described below in connection with FIG. 4, each model can make a decision, based on the context of the current query and past observations, on an action to take, and one of the models can determine that the virtual machine corresponding to the model is to execute the query. In some embodiments, model generator 306 can cause computing service 102 to launch one or more new virtual machines, to release one or more virtual machines, and/or can provide the query to the selected virtual machine.

FIG. 4 shows an example 400 of tiered models that can select a particular virtual machine to perform an incoming query in accordance with some embodiments of the disclosed subject matter. As shown in FIG. 4, models representing various virtual machines of different configurations can be arranged in tiers, where each tier represents a particularly configuration of virtual machine that is available. In some embodiments, each virtual machine can be represented by a corresponding model that is generated using reinforcement learning techniques. In general, reinforcement learning problems include an agent that exists in a state, and selects from a number of actions. Based on the state and action selected, the agent receives a reward (e.g., some feedback on the results of the action), and is placed into a new state. In such problems, the agent's goal is to use information about its current state and its past experience to maximize the reward it receives over time. The challenges faced by users in cloud environments can be conceptualized as being analogous to such a reinforcement learning problem. For example, in the cloud database context, the agent can correspond to the application, the state can correspond to the currently provisioned set of machines and the queries they are processing, the actions can correspond to a set of provisioning and query dispatching decisions, and the reward can be inversely proportional to the cost paid to the IaaS provider for processing each query.

In some embodiments, an approach to modeling a reinforcement learning problem can be to use a contextual multi-armed bandit (CMAB) technique to organize a group of models. Conceptually, in such an approach a gambler (i.e., agent) plays a row of slot machines (one-armed bandits) and decides which machines to play (i.e., which arms to pull) in order to maximize the sum of rewards earned through the sequence of arm pulls. In each round, the gambler decides which machine to play (action a) and observes the reward (c) of that action. The decision is made by observing the context of the various machines (e.g., a feature vector x) which summarizes information about the state of the machines at this iteration. The gambler then can improve their strategy through an observation {a, x, c} of the outcome of the previous decision, which can be added to an experience set [symbol] . The gambler aims to collect information about how the feature vectors (x) and rewards (c) relate to each other so that they can predict the best machine to play next by looking at the current feature vector.

In some embodiments, the workload and resource management problem of a cloud database can be modeled as a tiered network of CMABs, as shown in FIG. 4. As shown in FIG. 4, each running virtual machine can correspond to a “slot machine” in one of several tiers, where each tier represents a distinct virtual machine configuration available through the IaaS provider. In some embodiments, different tiers can be placed into an order based on price and/or performance/resource criteria. A model corresponding to each virtual machine can select a particular action (arm): Accept, Pass, or Down.

In some embodiments, when a query is received by the system, query-related features can be collected (e.g., context collected by context collector 302), and the root CMAB (e.g., the top left VM 110-1 in FIG. 4) can select an action. The model makes a decision based on the observed context and previously collected observations (e.g., experience collected after past decisions). If the Accept action is selected, the query is added to the execution queue of the virtual machine corresponding to the CMAB. If the Pass action is selected, the query is passed to the next CMAB in the same tier, and if there is no other CMAB on that tier, the system generates a corresponding CMAB (and provisions a new virtual machine corresponding to the CMAB if it accepts the query). If the Down action is selected, the query is passed downwards to the first CMAB in the next tier. However, CMABs in the last tier cannot select Down. The network described in connection with FIG. 4 contains no cycles, and empty CMABs are not permitted to select Pass (but may select Down). Using the above rules, a query must eventually be accepted by some CMAB. Note that, in some embodiments, the CMAB network can reside entirely inside of a computing device (e.g., a single server, a single virtual machine, etc.), and queries do not need to be passed through a computer network.

In some embodiments, after the query is executed by the virtual machine corresponding to the CMAB that Accepted the query, the cost for each decision is determined. For example, the cost can include fees to provision a new virtual machine (if a new virtual machine was provisioned), fees for processing that query on the virtual machine (e.g., based on the time it took to execute the query), and any costs incurred from violating the SLO. These costs can be represented as:

c=fₛ+fᵣ×l_{q}+p(q)

where fₛ are startup fees, fᵣ is the metered cost for the virtual machine that executed the query (e.g., per second, per millisecond, etc.), l_{q} is the query's execution time, and p(q) represents applicable penalties incurred. Note that, after execution of the query has completed, the query latency l_{q} is known.

In some embodiments, the final cost c can be used as a measure of how the quality of decisions made by a particular CMAB were, where lower costs correlate with higher quality decisions. In some embodiments, information about each completed query and its associated cost (c), along with the action selected by each CMAB (a), and the context (x) of the CMAB at the time the decision was made, can be used to “backpropogate” new information to all the CMABs involved in processing the query. For example, when execution of a query completes, each CMAB that the query passed through can record (1) its context (x) when the query arrived, (2) the action selected (a), and (3) the cost incurred by the network as a whole to execute the query (c), forming a new observation {a, x, c}. In some embodiments, each CMAB can adds the new observation to its set of experiences [symbol] , providing each CMAB with additional information. If the cost of a CMAB taking action a in context x produced a relatively high cost, the CMAB will be less likely to select that same action in similar contexts. If the cost was relatively low, the CMAB will be more likely to select that action in similar contexts. As more queries move through the system, each CMAB's corpus of experience grows, and the system as a whole can learn to make more cost-effective decisions.

For example, a CMAB network may initially have limited experience. In such an example, the network may have only received queries that are too computationally expensive to be efficiently processed on the first tier of virtual machines (e.g., virtual machines with limited memory and/or processing resources), but the network may have nevertheless chosen to execute every query on one of two virtual machines in the first tier (resulting in violations of a SLO of the database management system). In such an example, each CMAB has observed a relatively high cost for each query, as the queries took a relatively long time to execute (increasing l_{q}), and each query failed to meet its SLO (increasing p(q)). When a new query arrives that is similar to the previous queries, in light of past experience, the CMABs on the first tier are less likely to select the Accept option because their experience tells them it is associated with high cost. Eventually, one of the CMABs selects the Down action. When it does so, the query can be accepted by a CMAB corresponding to a virtual machine in the second tier, and the CMAB that selected down will associate a lower cost with its context and the Down action, making Down more likely to be selected in the future in a similar context (e.g., for similar queries). In this way, the system can learn that certain queries are too expensive to be processed on the first (e.g., cheaper) tier of virtual machines.

In some embodiments, a tiered network of CMABs where costs are “backpropogated” to all involved virtual machines can learn to handle many complexities found in cloud environments without user intervention. In some such embodiments, since each CMAB involved in placing a query receives the eventual cost incurred executing the query, the entire network can learn advanced strategies. For example, the tiered network of CMABs can pass queries to machines with an appropriately warm cache to handle the query that has been received. In a more particular example, a first virtual machine in a network has information cached that is helpful in processing queries of type A, and the second machine in the network has information cached that is helpful for processing queries of type B. In such an example, CMABs involved in placing a query of type A can learn that when the query of type A is processed by the first virtual machine a relatively low cost is incurred. More particularly, the CMAB corresponding to the first virtual machine can observe a relatively low cost when the Accept action is selected for such queries. Whereas CMABs involved in placing a query of type B can learn that when the query of type B is processed by the second virtual machine a relatively low cost is incurred. More particularly, the CMAB corresponding to the first virtual machine can observe a relatively low cost when the Pass action is selected for queries of type B. Since the costs are shared, searching for a low cost strategy at each CMAB individually can generate similar results to searching for a low cost strategy for the network as a whole.

In some embodiments, only having Accept, Down, and Pass actions available (at most), a virtual machine can never place a new query ahead of a query that had already been accepted. Accordingly, the system is restricted to using a FIFO queue at each machine. In some embodiments, the Accept action can be “split” into smaller arms representing various priorities to facilitate query scheduling (e.g., Accept High, Accept Medium, and Accept Low). Each of the new accept arms can represent placing a query into a high, medium, or low priority queue respectively. When a processing of a query completes, the head of the high priority queue can be processed next, and if the high priority queue is empty, the head of the medium priority queue is processed, etc. While this modification can allows the system to reorder incoming queries to a limited extent, it increases the complexity of the model by creating many more options (and correspondingly increasing the amount of information in the context corresponding to each incoming query).

In some embodiments, features that can be used by CMABs to make decisions on which action to take can be extracted upon arrival of a query (e.g., by context collector 302). These features can serve as a proxy for the current state of the system, and should contain enough information for an intelligent agent to learn the relationship between the features, actions, and monetary cost.

In some embodiments, the context x can include query-related features and/or virtual machine-related features. As the goal is to model the monetary cost of an action, not the exact latency of a particular query, the features used can include features beyond metrics that are direct casual factors of query latency. While none of the features are generally enough on their own to indicate the cost of an action, and while some features may appear to be only tangentially related to the cost of the action, the combination of features can create a description of the context that is sufficient to model the cost of each action, given the context.

In some embodiments, the features can include features that facilitate the system learning if a given virtual machine is suitable for a particular query (e.g., due to memory requirements), which queries are to be expected to be long running (e.g., due to a high number of joins), and features correlated with cache behavior. Since analytic queries are often I/O-bound, utilizing caching can be critical to achieving relatively high performance. Accordingly, a cache-aware service may increase throughput by placing queries with similar physical plans sequentially on the same machine, preventing cache evictions and thrashing. Note that features described herein may be appropriate for analytic read-only workloads, but they are merely provided as examples, and are not intended as a complete or optimal set.

In some embodiments, the system can use various query-related features that can be extracted from the query plan generated before the query is executed. For example, identifying information of tables used by the query can be used as a feature. In such an example, tables used by the query can be extracted to allow the model to learn, at a relatively low level of granularity, which queries access the same data. This can facilitate the use of caching when executing queries accessing similar tables on the same virtual machine.

As another example, the number of table scans specified by the query can be used as a feature. In such an example, the number of table scans of the query (extracted by the query's execution plan) can facilitate models learning when to anticipate long execution times (e.g., as table scans are often less efficient than index-based scans).

As yet another example, the number of joins specified by the query can be used as a feature. In such an example, because table joins often represent relatively large increases in cardinalities and/or time-consuming processes, the number of joins in a query can be an informative feature.

As still another example, the number of spill joins specified by the query can be used as a feature. In such an example, spill join operators, which are joins that the query optimizer of the database management system knows will not fit in memory, require disk I/Os due to memory (e.g., RAM) constraints. This feature can facilitate learning by models related to which queries should be given to virtual machines associated with more memory, and may indicate which queries may have high latency.

As a further example, cache reads specified by the query plan can be used as a feature. In such an example, the cache reads can represent the number of table scan operations that overlap with data currently stored in the cache. This is can particularly useful when multiple queries access the same set of tables, but with varying physical plans. In such a situation, table usage information is not sufficient for the model to be cache-aware. In combination with the tables used by the current and previous queries, this feature can provide information about how a query will interact with the cache.

In some embodiments, the system can use various virtual machine-related features that can represent the state of one or more virtual machines that are running when a query is received. Using such features, the model can be aware of the resources available on each running virtual machine, and available virtual machine configurations. These features can help the model make decisions on which action to take by indicating how a particular virtual is performing, by indicating whether there is a “noisy neighbor,” etc. Virtual machine-related features can be collected when a query arrives at a CMAB (e.g., the data can be collected from the corresponding virtual machine), while another query may still be executing. In some embodiments, the features can be collected using any suitable technique or combination of techniques, such as using standard Linux tools. Any suitable virtual machine features or combinations of features can be used as context for a model. For example, memory availability can be used as a feature. In such an example, this can be the amount of RAM currently available in the virtual machine. This can help the model predict how RAM pressure from other queries, the operating system, etc., may affect query performance. It can also facilitate differentiation between virtual machine types with different amounts of RAM.

As another example, the I/O rate of the virtual machine can be used as a feature. In such an example, this feature can represent the average number of physical (disk) I/Os done per minute over the last query execution. This can help the model predict when a machine's storage is performing poorly, as well as providing a general gauge of the virtual machines I/O capacity for the model, which may differ among virtual machines within the same tier.

As yet another example, the number of queries in the queue of a virtual machine can be used as a feature. In such an example, the model can track the number of queries waiting in the corresponding machine's queue. This feature can help the model learn when a queue is too full (e.g., when adding another query to the queue would raise costs more than passing the query to another virtual machine and/or another tier), suggesting that another accepted query would have to wait too long before being processed.

As still another example, the tables used by last query accepted by the model can be used as a feature. In such an example, this can indicate which tables were used by the previous query, which can help the models learn which virtual machine might have useful information in its cache for the current query.

As a further example, the network transfer cost associated with executing the query can be used as a feature. In such an example, this can be used when data is partitioned across multiple virtual machines, which can require the node that executes the query to request necessary data from one or more other nodes. Depending on the query and the distribution of data across the cluster, assigning the query to different nodes might incur different network transfer costs. This can indicate the amount of data a node has to move over the network from other nodes in order to process a query. It can be roughly estimated by summing the size of all non-local partitions that may be required by the query. Note that, in some embodiments, the context provided to a particular CMAB can include contextual information about the query, and contextual information about only the virtual machine that corresponds to the CMAB. However, in some embodiments, contextual information about one or more other virtual machines can be included in the contextual information, such as the next virtual machine in the same tier, all virtual machines in the tier that are after the current virtual machine, the first virtual machine in the next tier, etc.

As shown in FIG. 4, in example 400 a query is passed from a first CMAB (i.e., it selects the Pass action) corresponding to a first virtual machine 110-1 in the first tier, to a CMAB associated with a second virtual machine 110-2 in the first tier, which chooses the Down action, and sends the query to a CMAB associated with first virtual machine 112-1 in the second tier. The CMAB associated with virtual machine 112-1 in the second tier selects the Pass action, and generates a new CMAB associated with a second virtual machine 112-2 in the second tier (which must be provisioned, as it was not previously executing). The CMAB associated with virtual machine 112-2 selects the Down action, and sends the query to a CMAB associated with a first virtual machine 402-1 in a third tier, which selects the Accept action (e.g., because a second virtual machine 402-2 has a large que, because virtual machine 402-1 has no que, because virtual machine 402-1 has tables in its cache that are referenced by the query, etc.).

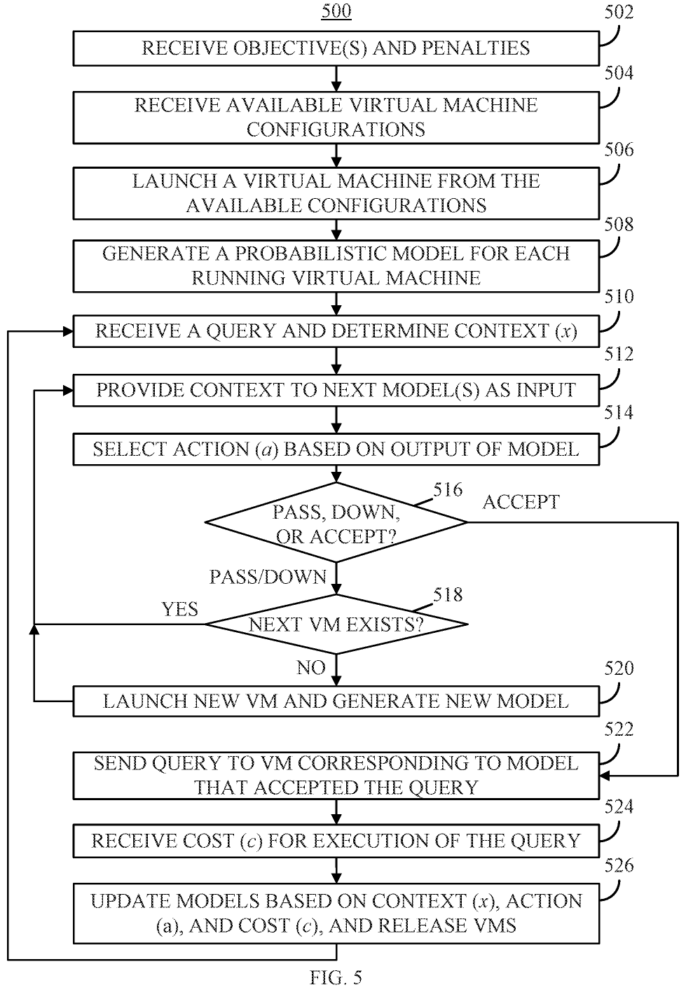

FIG. 5 shows an example 500 of a process for distributing database queries across a metered virtual network in accordance with some embodiments of the disclosed subject matter. As shown in FIG. 5, at 502, process 500 can receive one or more service level objectives and associated penalties for violating the SLO. As described above, SLOs can be on a per query basis and/or on a workflow basis.

At 504, process 500 can receive information regarding available virtual machine configurations that can be launched by a compute service (e.g., an IaaS provider) as part of a distributed database management system. For example, different virtual machine configurations can be associated with different amounts of resources (e.g., processing power, RAM, etc.). As another example, different virtual machine configurations can be associated with different applications, operating systems, libraries, etc.

At 506, process 500 can launch at least one virtual machine of the available virtual machine configurations. In some embodiments, as described above in connection with FIG. 4, process 500 can launch a lowest cost configuration in a first tier as the first virtual machine. In some embodiments, the virtual machine launched by process 500 can be associated with all or part of a database.

At 508, process 500 can generate a probabilistic model for each running virtual machine. As described above in connection with FIG. 4, the model can be a CMAB that can select one of at least two actions, Pass or Accept, and sometimes a third action, Down (when the CMAB is not in the final tier).

At 510, process 500 can receive a query, and can determine contextual information. For example, the context can include a feature vector x that can include one or more items of information about the query and/or one or more items of information about the running virtual machines.

At 512, process 500 can provide at least a portion of the contextual information to a next probabilistic model. For example, as described above in connection with FIG. 4, contextual information about a state of a first virtual machine in the lowest cost tier and information about the query can be provided to a first CMAB corresponding to the first virtual machine. After the initial placement, a portion of the contextual information can be provided to the next CMAB (or a new CMAB) in the tier (e.g., the contextual information about the virtual machine corresponding to the next CMAB, and the contextual information about the query), or providing the portion of the contextual information to the first CMAB in the next tier.

At 514, process 500 can select an action based on the output of the probabilistic model with the contextual information provided as an input. In some embodiments, the model can use any suitable technique or combination of techniques to select an action based on the contextual information and previous observations. While acceptable results can sometimes be achieved with very limited experience, exploiting the knowledge by repeating “safe” decisions might pass up opportunities for large improvements. Accordingly, improving the model over time can require the exploration of new (potentially high-cost) decisions. In light of this, each CMAB can select actions so that some new strategies are explored without always passing up known “safe” decisions (the strategy for selecting an action can attempt to address the exploration-exploitation dilemma).

In some embodiments, the model can use Thompson sampling, which can involve iteratively choosing actions for the model and incorporating feedback, to attempt to address the tradeoff between exploration and exploitation of existing knowledge. In Thomson sampling, an arm (i.e., action) is chosen according to the probability of that particular arm being the best arm given the experience so far. Thompson sampling is generally self-correcting and relatively efficient to implement.

In some embodiments, Thompson sampling can be used by each CMAB in the network. Each time a query finishes executing, each CMAB that made a decision related to that query can adds to it set of observations [symbol] a new tuple {a, x, c}, where a is the decision it made, x is the context used when making that decision (including query-related features and/or virtual machine-related features), and c is the cost of the decision. This leads to a CMAB's set of experiences [symbol] growing over time.

In some embodiments, to select actions based on past experience, a likelihood function P(c|θ, a, x), where θ are the parameters of a model that predicts the cost c for a particular action a given a context x. Given the perfect set of parameters θ*, this model would exactly predict the cost for any given action and context, and the problem of selecting the optimal action would be reduced to finding the minimum cost action a where the cost of each action is predicted by this perfect model. However, as it is impossible to know the perfect model (i.e., the perfect parameters θ*) ahead of time, the model can sample a set of parameters θ′ from the distribution of parameters conditioned on past experience, P(θ| [symbol] ). Then the model can randomly select an action according to the probability that a is optimal as follows: sample a set of model parameters θ′ from P(θ| [symbol] ), and choose an action that minimizes cost assuming that θ′=θ*:

$${min}_{{a}^{′}} 𝔼 ( c \vert {a}^{′} , x , {θ}^{′} )$$

Conceptually, using this approach, the system instantiates its beliefs (θ′) randomly at each time step according to P(θ| [symbol] ) (i.e., selects a model for predicting the cost based on the probability that the model explains the experience collected so far), and then acts optimally assuming this random model is correct. By contrast, if a model that only exploited existing knowledge was desired, the model would not sample from P(θ| [symbol] ), but would instead select the mean value of P(θ| [symbol] ), which would maximize exploitation. On the other hand, choosing a model entirely at random maximizes exploration. Using Thompson sampling (drawing θ from P(θ| [symbol] )) can balances exploration and exploitation.

In general, Thompson sampling is well suited for selecting actions in the context of cloud computing. While the effectiveness of traditional techniques relies on accurately modeling many complex systems (e.g., virtual machines hosted on cloud infrastructures can exhibit erratic behavior when load is high; optimizers in modern databases may use probabilistic plan generation techniques, potentially creating variance in how identical queries are processed; query execution engines can exhibit sporadic behavior from cache misses, context switches, or interrupts, etc.), using Thomson sampling facilitates managing complexity across the entire cloud environment end-to-end by probabilistically modeling the relationship between various context features and cost. When an action has an unexpectedly low or high cost, the system does not need to diagnose which component (e.g., the VM, the optimizer, the execution engine, the hardware itself, etc.) is responsible. The system can simply add the relevant context, action, and cost to the experience set. If the unexpected observation was a one-off outlier, it will not have a significant effect on the sampled models, but if the unexpected observation was indicative of a pattern, Thompson sampling can increase the chances that the pattern will be explored and exploited over time.

In some embodiments, the system can use REP trees (regression trees) to model the cost of each potential action in terms of the context. The parameter set θ can represent the splits of a particular tree model (i.e. the decision made at each non-leaf node). To utilize REP trees and Thompson sampling, the system needs to sample a regression tree based on past experience (in other words, to sample a θ from P(θ| [symbol] )). Since generating every possible regression tree would generally be inefficiently expensive (as there are O(nⁿ) possible trees), the system can utilize bootstrapping. In order to sample from P(θ| [symbol] ), the system can select n=| [symbol] | tuples from [symbol] with replacement (so the same tuple may be selected multiple times, or not at all) to use as a training set for the regression tree learner. Bootstrapping can facilitate accurately producing samples from P(θ| [symbol] ), because there is a non-zero chance that the entire sampled training set will be composed of a single experience tuple (full exploration), and the mean of the sampled training set is exactly [symbol] (full exploitation). While REP trees can be used relatively quickly and easily, this is merely an example and any sufficiently powerful modeling technique (e.g., neural networks, SVR, etc.) or combination of techniques can be used.

While systems that use Reinforcement learning and/or Thompson sampling generally treat each arm of a CMAB as independent random variables, and assume that the next context observed is independent of the action taken (neither of these conditions hold for the CMABs described herein), techniques used to solve the CMAB problem still work well, as in other applications of machine learning techniques to real world problems, like natural language processing, and, in the specific case of Thompson sampling, web advertising and route planning.

In some embodiments, configuring the system to attempt to balance exploration and exploitation can lead to high-cost strategies being considered, especially when little information is available. To reduce such catastrophic “learning experiences,” the system can use heuristics for limiting the search space. For example, the system can forbid picking the Accept option when a machine's queue has more than b queries in it. From the remaining actions, each CMAB can pick the one that is expected to minimize the cost. This technique is sometimes referred to as beam search. In some embodiments, for many SLOs an appropriate threshold b can be calculated. For example, if the SLO requires that no query takes longer than X minutes, b can be set to

$$\frac{X}{{q}_{m i n}} ,$$

where qₘᵢₙ is a lower bound on query execution time. This can prevent the system from placing too many short queries on the same queue, and violations would be even worse with longer running queries. Note that even without beam search, the system eventually learns that no more than b queries should be placed in the queue at once, but eliminating these options a priori can accelerate convergence. However, setting b too low can eliminate viable strategies and cause the system to converge to a local optima (rather than an overall optima).

In some embodiments, placing other constraints on the strategy space can decrease the time required to converge to a “good” strategy. For example, CMABs corresponding to virtual machines with no queries in their queues can be prohibited from selecting the Pass arm. This can prevent provisioning multiple new virtual machines to process a single query. Note that while such restrictions may accelerate convergence, they are not required, as the system eventually converges to a “good” strategy without them. As with the b value, limiting the strategy space too much can unknowingly eliminate a good strategy.

In some embodiments, because the experience [symbol] of each CMAB consists of action/context/cost triples {a, x, c}, and since a new triple is added to [symbol] on a number of CMABs each time a query completes, memory usage of the experience array could potentially grow to be prohibitive. Even though each experience tuple can be represented using relatively little space (e.g., using the features described above, encoding the cost, action, and each feature as a 32-bit integer requires only 448 bits per experience tuple), the system continues to use more memory as long as it continues to process queries. However, since query workloads may shift over time, newer experiences are generally more likely than older experiences to be pertinent to the current environment. Accordingly, in some embodiments, the size of the experience set [symbol] can be bounded, and the oldest experiences can be removed (e.g., by overwriting) when the experience set is at the maximum size and new experiences arrive. Alternatively, each experience tuple can be associated with a weight, and the system can probabilistically decrease the weights of older experiences as new experiences are added, which can eventually lead to removing the old experiences when they no longer have a significant effect on performance (e.g., when the weight falls below a threshold).

At 516, if at 514, the CMAB selected Pass or Down, process 500 can determine, at 518, whether a next virtual machine exists (i.e., the next virtual machine in the same tier for the Pass action, or the first virtual machine in the next tier for the Down action). If process 500 determines that the next virtual machine does exist (“YES” at 518), process 500 can provide the contextual information about the query to the next CMAB at 512. Otherwise, if process 500 determines that the next virtual machine does not exist (“NO” at 518), process 500 can move to 520. At 520, process 500 can launch a new virtual machine in the appropriate tier (e.g., the same tier as the virtual machine corresponding to the previous CMAB when Pass was selected, or in the next tier when Down was selected), and can generate a new corresponding probabilistic model. Note that, in some embodiments, a new probabilistic model can be associated with an empty experience set [symbol] . Additionally or alternatively, in some embodiments, a new probabilistic model that corresponds to a position in the tier that was previously occupied by a virtual machine that had been release can be associated with the experience set corresponding to the virtual machine that was released.

Returning to 516, If the CMAB at 514 selected Accept, process 500 can move to 522, and can route the query received at 510 to the virtual machine corresponding to the CMAB that selected Accept.

At 524, process 500 can receive cost information related to the execution of the query by the selected virtual machine. For example, as described above, process 500 can receive information about how much time it took for the query to be executed by the virtual machine, and information that can be used to determine whether execution of the query caused (or contributed to) an SLO being violated. Process 500 can calculate a cost metric (c) based on the received information.

At 526, process 500 can update the probabilistic models that participated in routing the query by adding context/action/cost tuples (e.g., {x, a, c}) to the experience set ( [symbol] ) associated with each model, which can contribute to the selection of the next action by each model when a new query is evaluated. Process 500 can return to 510 to receive a new query. Note that the next query may be processed before the experience from the last query is added to the models, as execution of the previous query may be delayed if it was added to a queue.

In some embodiments, process 500 can release (e.g., shut down) virtual machines that are not receiving a sufficient number of queries to justify continuing to pay for their operation. While many relatively simple techniques can be used to determine when to release resources, these simple techniques typically do not perform well in most real-world environments. For example, process 500 can determine when a virtual machine has no queries in its processing queue, and shut down any virtual machines that have zero pending queries. However, this technique can increase costs when a new query arrives just after the previous query finishes, necessitating re-provisioning the virtual machine that was just released, and paying the cost of initializing the virtual machine again. As another example, if the arrival time of the next query to be served on a particular virtual machine is known, process 500 can calculate if it would be cheaper to keep the virtual machine running until the next query arrives or to shut down the virtual machine and restart the virtual machine when the query arrives. However, in practice this is not usual possible as upcoming queries are unknown. As yet another example, process 500 can keep a virtual machine active for some constant number of seconds j after its queue empties, and then shut the virtual machine down if it still has not received a query to process. However, while this approach works well when the query arrival rate is relatively constant, it can be expected to perform relatively poorly when queries arrive at an unknown and variable rate.

In some embodiments, process 500 can use any suitable technique or combination of techniques to determine when a virtual machine is to be released. For example, in some embodiments, process 500 can use a hill-climbing technique to determine whether to shut down a virtual machine or keep it running in anticipation of a future task. In such an example, a variable k can be maintained in connection with each virtual machine (e.g., by process 500, by the virtual machine itself, etc.) that represents the number of seconds to wait once the virtual machine is idle before shutting down. For all machines, k can be initialized to one second. If no query arrives after k seconds, the virtual machine is shut down (e.g., by process 500 sending an API call to the service provider, by a process initiated by the virtual machine, etc.). Otherwise, if another query arrives before k seconds have passed, the virtual machine processes that query and remains online.

In some embodiments, the variable k can be adjusted by determining if the cost incurred by waiting for the query to arrive was larger than the cost associated with shutting down the virtual machine and launching the virtual machine when the query is received. If shutting the virtual machine down would have been less costly, k can be adjusted such that k′=k/λ, where λ is a learning rate, described in more detail below. On the other hand, if the next query arrived after the virtual machine was already shut down, if it would have been less costly to maintain the virtual machine instead k can be adjusted such that k′=k×λ.

In some embodiments, λ, the learning rate, is a value greater than one (i.e., λ>1) that represents the balance between the value of new information versus the value of past experience. Setting λ closer to one causes k to adjust more slowly (far-sighted), whereas setting λ to a high value causes k to adjust more quickly (near-sighted). While a system can benefit from tuning λ, setting λ=2 can generate relatively high quality results in many situations with typical query arrival rates (e.g., an arrival rate that resembles the query arrival rate of many systems currently being used).

Alternatively, in some embodiments, any reinforcement learning technique with a continuous action space can be applied to learn the wait period before shutting down a virtual machine. Examples of such algorithms include Monte Carlo-based approaches, continuous Q-learning, and the HEDGER algorithm. Each of these techniques can be applied to select the next wait time after a virtual machine becomes idle. Since a cost can be generated for each decision (after another query is accepted by that virtual machine), any contextual continuous action space approach can be applied. In some embodiments, when a virtual machine is released the probabilistic model and experience associated with that virtual machine can be removed from memory, removed from storage, overwritten, a flag can be set indicating that the data corresponding to the CMAB can be overwritten, and/or can be otherwise disposed of. Alternatively, in some embodiments, a CMAB corresponding to a virtual machine that has been released can be maintained for a predetermined amount of time, and can be associated with a new virtual machine that is provisioned in the tier corresponding to the virtual machine that was released.

Some of the techniques described herein were implemented, and the effectiveness and training overhead were evaluated on a compute service (ELASTIC COMPUTE CLOUD (EC2) available from AMAZON WEB SERVICES®), using three types of machines: t2.large, t2.medium, and t2.small. In the majority the tests, workloads were generated from TPC-H templates. However, tests were also performed using a larger set of templates extracted from the performance testing suite available from VERTICA SYSTEMS. Unless otherwise stated, all queries were executed on a 10 GB database stored in Postgres (available from PostgreSQL Global Development Group), and each virtual machine used a complete copy of the entire database (i.e., a fully-replicated database).

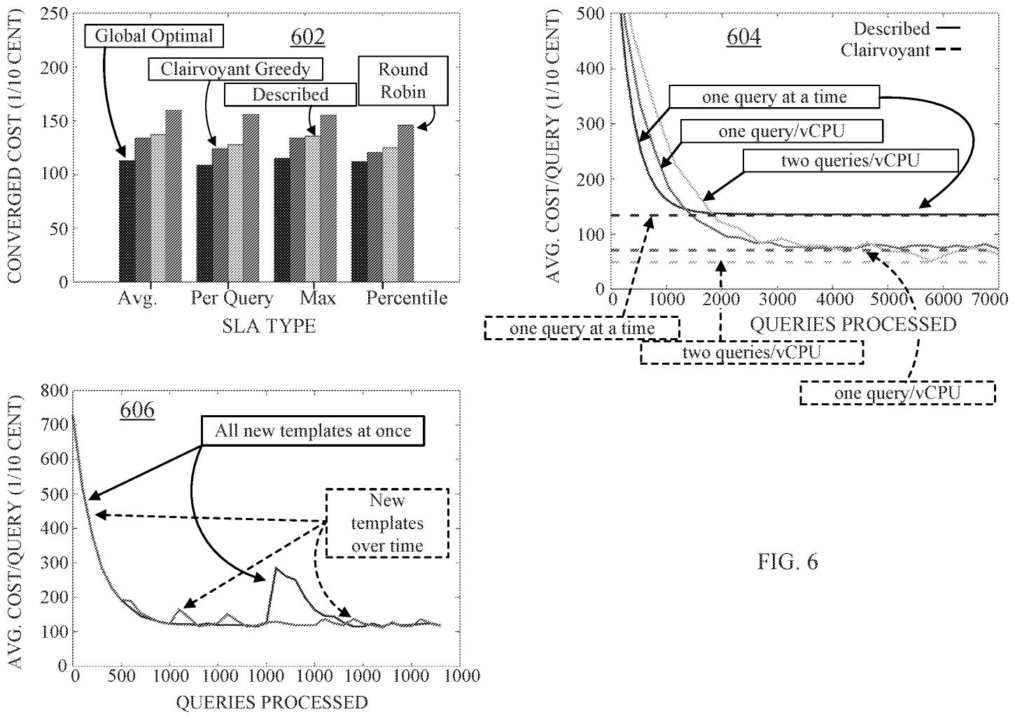

FIG. 6 shows an example of representative results of tests measuring the effectiveness of techniques described herein in accordance with some embodiments of the disclosed subject matter. Query arrival was modeled as a non-homogenous Poisson process where the rate is normally-distributed with constant mean arrival rate of 900 queries per hour and variance of 2.5 (which is representative of real-world workloads). The tests measured the average cost of each executed query, and each point in FIG. 6 represents a sliding window of 100 queries.

Virtual machine features were extracted using via standard Linux tools. The query features were extracted by parsing the query execution plan. Calculating the number of spill joins, (i.e., the joins for which the query optimizer predicts that they will not fit in memory) can be challenging. Computing the exact number of spill joins in the query plan may depend upon accurate cardinality estimations for a specific query. The number of spill joins in a query plan were calculated using the following rule: a join of table T₁ and table T₂ was considered to be a spill join if, and only if, the maximum possible size of the result exceeds the amount of RAM (i.e., the total size of T₁ times the total size of T₂ exceeds the size of RAM), regardless of the join predicate involved. While this is a conservative estimation of which joins will spill, it has some meaningful relationship with query execution cost (as described below).

Techniques described herein were tested for the ability to enforce four commonly used SLO types: (1) Average, which sets an upper limit (of 2.5 times the average latency of each query template in isolation) on the average query latency so far; (2) Per Query, which requires that each query completes within a constant multiple (2.5) of its latency; (3) Max, which sets an upper limit on the latency of the whole workload (2.5 times the latency of the longest query template); and (4) Percentile, which requires that no more than 10% of the queries executed so far exceed a limit (2.5 times the average latency of the query templates in isolation). The monetary cost for violating the SLO was assumed to be one cent per second.

Techniques described herein were evaluated against the optimal strategy for these SLO types. Specifically, a sequence of thirty queries drawn randomly from TPC-H templates was generated and the optimal decisions (i.e., which virtual machines to use and query placements on them) to process the sequence with minimal cost was determined empirically. A system implemented using the techniques described herein was trained using the workload by repeating the sequence many times, allowing all thirty queries to finish before submitting the next sequence. Note that this lowered the average query arrival rate from 900 queries/hour to 200 queries/hour, until its cost converged. The system implemented using the techniques described herein was compared to a clairvoyant greedy strategy, which uses a perfectly accurate latency model to estimate the cost of each decision, and, upon the arrival of a new query, makes the lowest-cost decision. Finally, a simple round-robin scheduling strategy was tested to divide the thirty queries across seven virtual machines (i.e., the number of virtual machines used in the optimal solution). The comparison of the costs for the four SLOs is shown in graph 602 of FIG. 6.

As shown in 602, the system using the techniques described herein (labeled as “Described” in 602) achieves a final cost within a range of 8% to 18% more than the global optimum, but computing the optimal solution requires both a perfect latency model and a significant amount of computing time (in some cases the problem is NP-Hard). As shown in 602, the techniques described herein also represent a significant cost reduction over naive, round-robin placement. Finally, the system using the techniques described herein comes within about 4% of the clairvoyant greedy model. That is, the cost model developed using the techniques described herein—which only implicitly models query latency—can perform at almost the same level as an approach with a perfect latency prediction model.

The techniques described herein were able to converge to effective models when queries were executed concurrently, when performance prediction is quite challenging. Graph 604 shown in FIG. 6 shows the convergence of the cost per query over time for a system using the techniques described herein for various concurrency levels with a Max SLO. The results in 604 were generated using queries drawn randomly from TPC-H templates and their arrival time was drawn from a Poisson process. One query represents no concurrent executions (i.e., only one query was admitted at a time on each machine). One query/vCPU and Two queries/vCPU represent running up to one or two queries respectively per core on each virtual machine. In the two queries/vCPU case, t2.small machines run two queries at once, and t2.medium and t2.large machines run four queries at once. Note that when two queries were executed, each query was itself executed serially. That is, there was parallelism between queries, but not within queries.

As shown in 604, increased concurrency levels incur more training overhead (convergence takes longer), but a lower converged cost since the cost-per-VM-hour is the same regardless of how many CPU cores are utilized. As identifying the optimal strategy for these scenarios is not straightforward, the performance of the systems using the techniques described herein was evaluated against a clairvoyant greedy strategy. Again, the systems using techniques described herein performs within 4% of the clairvoyant greedy strategy. Hence, the direct cost modeling approach described herein handles high levels of concurrency with no pre-training. Both the systems implemented using the techniques described herein and the clairvoyant greedy strategy utilized fewer virtual machines at increased concurrency levels. With no concurrency, both strategies used an average of 45 VMs. With one or two queries per vCPU, both strategies used an average of 38 VMs.

Handling previously-unseen queries represents an extreme weakness of pre-trained query latency prediction models. However, a system using techniques described herein can efficiently handle these cases. Graph 606 in FIG. 6 shows cost curves for two different scenarios. In both scenarios, a system using techniques described herein begins processing a workload consisting of queries drawn randomly from 13 TPC-H templates, with the performance goal set to the Max SLO type described above. In the all new templates at once scenario, seven new query templates are introduced after the 2000th query has been processed. In the new templates over time scenario, a new query template is introduced every 500 queries. As shown in 606, introducing seven new query templates at once causes a notable increase in cost, but the system eventually recovers as it gains information about the new query templates. However, introducing queries slowly over time causes only a slight decrease in performance, and the system recovers from the small change faster than it did for the large change. This makes the techniques described herein well-suited for query workloads that change slowly over time.

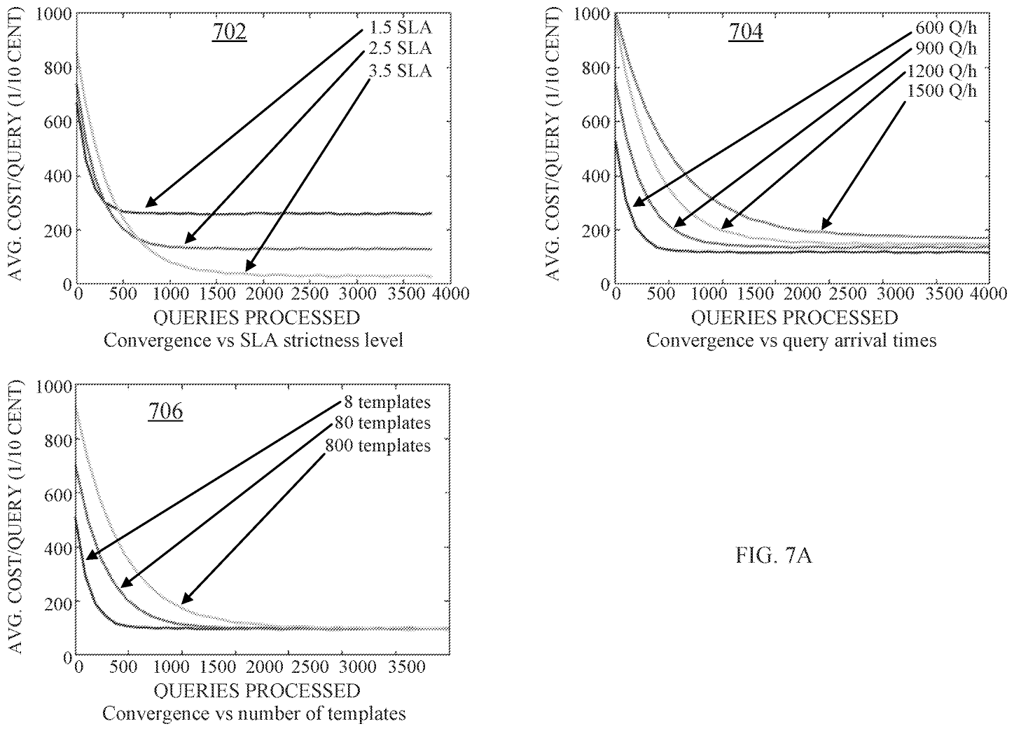

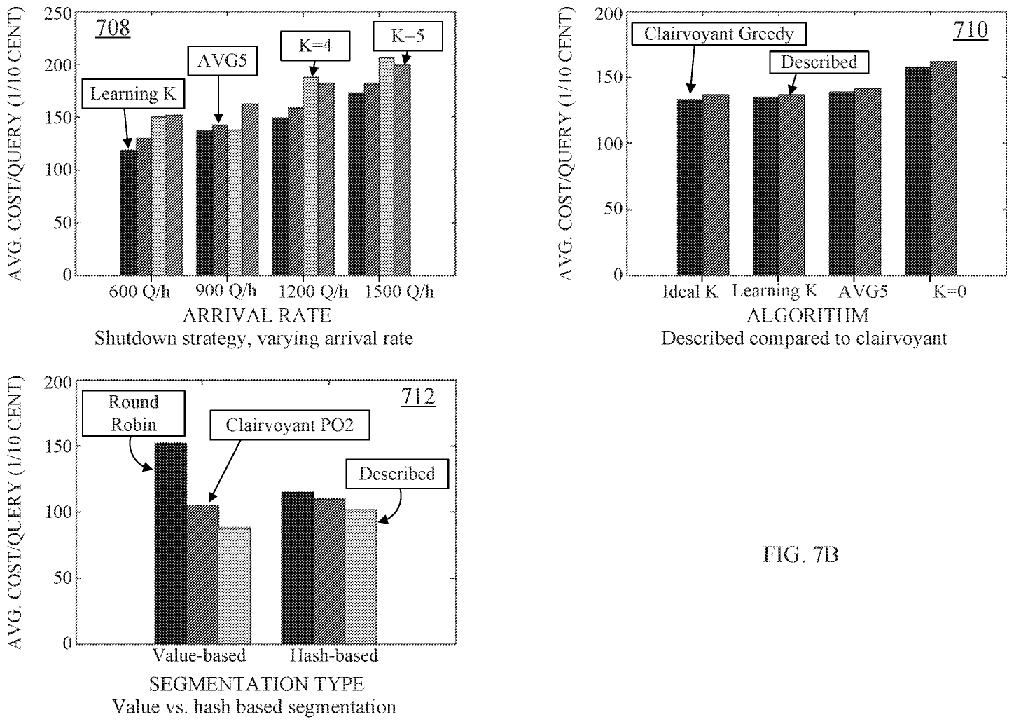

FIGS. 7A and 7B show convergence curves for techniques described herein in different scenarios and costs comparisons of various scenarios. As shown in FIG. 7A, graphs 702-706 each shows the average cost per query for a sliding window of 100 queries compared to the number of queries processed. Shown in 702 are convergence curves for various SLO strictness levels for the Max SLO type where the deadline for each query is set to 1.5, 2.5, and 3.5 times the latency of that query in isolation. Looser SLOs take longer to converge, but converge to a lower value. Tighter SLOs converge faster, but have higher average cost. This is because looser SLOs have a larger policy space that must be explored (there are more options that do not lead to massive SLO violation penalties), whereas tighter SLOs have smaller policy spaces.

Shown in 704 are convergence curves for various query arrival rates. The graph matches an intuitive notion that high query arrival rates should be more difficult to handle than low query arrival rates. Higher query arrival rates require more complex workload management strategies that take longer to discover. For example, with a low query arrival rate, a system using the techniques described herein may be able to assign all queries using a particular table to a single virtual machine, but with a high query arrival rate, it may have to figure out how to distribute these queries across several virtual machines.

Since TPC-H provides only a small number of query templates, performance was also evaluated on 800 query templates extracted from the analytic workload performance testing suite available from VERTICA SYSTEMS. These templates are used to measure the “across the board” performance of the VERTICA database, and thus they cover an extensive variety of query types. The generated queries were run against a 40 GB database constructed from real-world data. For consistency, Postgres was still used to store and query the data. Shown in 706 are convergence curves for randomly generated workloads composed of 8, 80, and 800 query templates. For the 8 template run, four query templates with the highest and lowest costs were selected (similarly, for the 80 query template run, 40 query templates with the highest and the lowest cost were selected) so that the average query cost is the same for all three runs. As shown in 606, higher template counts take longer to converge since the corresponding strategy space is larger, whereas workloads with fewer query templates exhibit less diversity, and the system is able to learn an effective strategy more quickly. Even when the template count is very large (e.g., 800), however, the system still finds good strategies after having seen a reasonable number of queries.

After a virtual machine is provisioned, the system must decide when (or if) to turn it off. Shown in 708 is a comparison of different shutdown strategies for various query arrival rates. A constant delay of K=4 (i.e., wait four seconds for a new query once the queue is empty) can be very effective for certain arrival rates (900 Q/h), but did not perform well for others (1200 Q/h, 1500 Q/h). Learning K represents the learning technique described above in connection with FIG. 5. AVGS sets the time to wait before shutting down a virtual machine to the average ideal wait time of the last five shutdown decisions that were made, and was calculated as follows: after deciding to keep a machine on or off, a calculation is performed to determine what the ideal delay would have been, and set the new delay to the average of the last five ideal delay values computed. K=0 represents shutting down a virtual machine immediately after its queue becomes empty. As shown in 708, Learning K is the best strategy among the four independent of the arrival rate. The increases in reward for Learning K are larger when the query arrival rate is slower, because slower arrival rates cause virtual machine queues to empty more frequently, making the decision on whether to shut down a machine or to keep it running (in anticipation of another query) more important.

Shown in 710 is a comparison of costs for the various strategies between a system using techniques described herein (labeled as “Described” in 710) and the clairvoyant greedy strategy using each of the shutdown strategies described above in connection with 708 for a query arrival rate of 900 queries per hour. For this test, comparisons to the ideal shutdown strategy were also made. This strategy works by “looking into the future” and retroactively making the correct decision about whether or not to shutdown a machine based on if a query will be placed onto it again in a profitable timeframe. This is done by iteratively running queries, noting the arrival time of the nth query on each machine, and then restarting the process (this time running to the (n+1)th query). This represents the optimal shutdown policy, given a particular strategy, and (while impossible in practice) can be used as a benchmark. As shown in 710, Learning K performs within 1-3% of optimal.

While fully-replicated database systems in which any virtual machine is capable of executing any query independently have many applications, modern analytic databases typically partition data across multiple machines. A test of using partitioned databases was performed using a cloud-deployment of a commercial analytic column store database. 20 TB of TPC-H data was generated and loaded into the commercial engine deployed on AMAZON WEB SERVICES (e.g., with instances deployed using EC2). The large fact table (lineitem) was partitioned and other tables were replicated. Two different partitioning schemes were used: value-based partitioning, in which a given partition will store tuples that have attribute values within a certain range, and hash-based partitioning, which partitions tuples based on a hash function applied on a given attribute. Each partition is also replicated by a factor of two.

For a system using techniques described herein, a cluster with three virtual machines was provisioned at the start of each test and the partitions assigned to each virtual machine were determined by the underlying commercial database engine. For both partitioning schemes, the system using techniques described herein was compared with two different techniques. First, a Round-Robin approach, which uses a fixed cluster size of n=21 virtual machines and dispatches incoming queries to these virtual machines in a circular order. All cluster sizes from n=1 to n=50 were evaluated, and n=21 was selected for comparison because it had the best performance for the workload. Second, a clairvoyant power of two technique (labeled as Clairvoyant PO2), which randomly selects two machines from the current pool and schedules the query on whichever of those two machines will produce the lowest cost (as determined by a clairvoyant cost model). Among the available machines the technique can choose from, three “dummy virtual machines” were included, that represent provisioning new virtual machines of the three EC2 types described above.

For these tests, the Max SLO metric was used. Shown in 712 is the converged cost for each partitioning scheme. For the hash-based partitioning, the system using the techniques described herein (labeled as “Described” in 712) outperforms the Clairvoyant PO2 technique by a relatively small margin. Hash-based partitioning allows for each node in the cluster to participate evenly (on average) in the processing of a particular query, as tuples are distributed evenly (on average) across nodes. Indeed, the system using the techniques described herein converged to a basic round-robin query placement strategy, but still intelligently maintained an appropriately sized cluster, in contrast to the round-robin method that uses a static cluster size.

The system using techniques described herein outperforms Clairvoyant PO2 more significantly when using value-based partitioning (i.e., by 16%). This partitioning schema allows for data transfer operations to be concentrated on the particular nodes that have the range values required by the query. In this case, the system using the techniques described herein learned to maximize locality (i.e., to place certain queries on nodes that have most (or all) the partitions necessary to process a certain query). Generally, the system using the techniques described herein learned to assign each query to a node that will incur low network cost, which leads to reduced query execution time and hence lower monetary cost. Note that the round-robin technique performs significantly worse with value-based partitioning than with hash-based partitioning, because an arbitrarily selected node is less likely to have as much data relevant to the query locally with value-based partitioning than with hash-based partitioning, causing more data to be sent over the network.

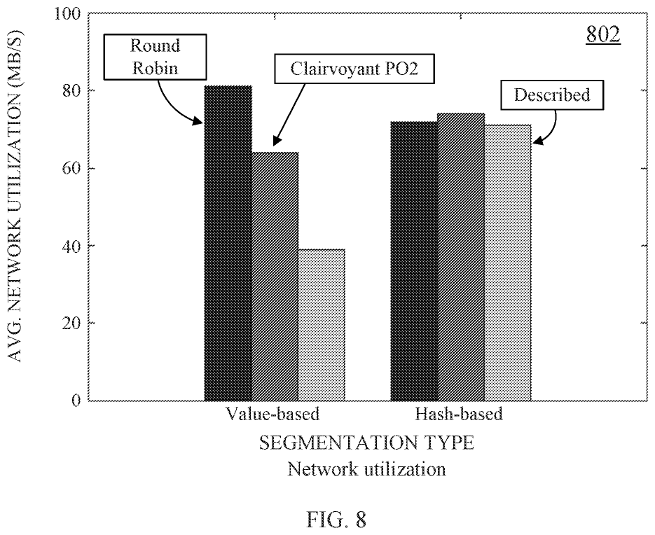

FIG. 8 shows an example of the average total network utilization during the test described above in connection with 712 in accordance with some embodiments of the disclosed subject matter. As shown in graph 802, networking overhead is a substantial factor in the performance differences shown in 712 of FIG. 7B. For hash-based partitioning, the network utilization is approximately equal for all three techniques, but for value-based partitioning, the system using the techniques described herein required substantially less data transfer. Generally, value-based partitioning needs to be carefully configured by an administrator, whereas hash-based methods are more easily performed without user intervention. However, the results shown in FIG. 8 show that value-based partitioning can lead to greatly reduced network utilization when combined with an intelligent workload management system.

Although the mechanisms described herein are described in connection with using reinforcement learning techniques to minimize the cost of executing incoming queries, similar techniques (with potentially different features) can be used to maximize (or minimize) other metrics, such as maximizing query throughput or minimizing query latency. Additionally, in some embodiments, the mechanisms can be used in combination with other techniques that are better suited when the type of queries that will be received is known. For example, supervised learning techniques can be used to distribute queries that are known to be similar to a training set of queries, while reinforcement learning can be used to distribute queries that are unknown (i.e., not necessarily similar to the training data set).

In some embodiments, any suitable computer readable media can be used for storing instructions for performing the functions and/or processes described herein. For example, in some embodiments, computer readable media can be transitory or non-transitory. For example, non-transitory computer readable media can include media such as magnetic media (such as hard disks, floppy disks, etc.), optical media (such as compact discs, digital video discs, Blu-ray discs, etc.), semiconductor media (such as RAM, Flash memory, electrically programmable read only memory (EPROM), electrically erasable programmable read only memory (EEPROM), etc.), any suitable media that is not fleeting or devoid of any semblance of permanence during transmission, and/or any suitable tangible media. As another example, transitory computer readable media can include signals on networks, in wires, conductors, optical fibers, circuits, or any suitable media that is fleeting and devoid of any semblance of permanence during transmission, and/or any suitable intangible media.

It should be noted that, as used herein, the term mechanism can encompass hardware, software, firmware, or any suitable combination thereof.

It should be understood that the above described steps of the processes of FIG. 5 can be executed or performed in any order or sequence not limited to the order and sequence shown and described in the figures. Also, some of the above steps of the processes of FIG. 5 can be executed or performed substantially simultaneously where appropriate or in parallel to reduce latency and processing times.

Although the invention has been described and illustrated in the foregoing illustrative embodiments, it is understood that the present disclosure has been made only by way of example, and that numerous changes in the details of implementation of the invention can be made without departing from the spirit and scope of the invention, which is limited only by the claims that follow. Features of the disclosed embodiments can be combined and rearranged in various ways.

What is claimed is:

1. A method for distributing database queries across a metered virtual network, comprising:
receiving a first query at a first time;
selecting, using a plurality of probabilistic models, a first virtual machine of a plurality of virtual machines provided via the metered virtual network to execute the first query, wherein each of the plurality of probabilistic models is associated with one of the plurality of virtual machines;
receiving information indicative of a monetary cost of executing the first query using the first virtual machine, wherein the cost is based at least in part on the execution time of the first query by the first virtual machine;
providing an observation to each of the plurality of probabilistic models, wherein the observation includes at least information about the cost of executing the first query, and information about an action selected by the probabilistic model in connection with the first query; and
reducing, over time, the costs of using the metered virtual network to execute queries that are received after the first query based on the observations.

2. The method of claim 1, further comprising:
determining a context based at least in part on the query and based on a state of first virtual machine at the first time; and
providing the context to a first probabilistic model of the plurality of probabilistic models that is associated with the first virtual machine as a feature vector.

3. The method of claim 2, further comprising:
predicting, using the first probabilistic model, the monetary cost of the first virtual machine executing the query based on the context; and
predicting, using the first probabilistic model, the monetary cost of passing the query to a second virtual machine of the plurality of virtual machines.

4. The method of claim 3, further comprising selecting the first virtual machine to execute the query based on the predicted cost of the first virtual machine executing the query being lower than the predicted cost of passing the query to the second virtual machine.

5. The method of claim 4, wherein the first virtual machine and the second virtual machine are part of a group of virtual machines that have a particular configuration.

6. The method of claim 4, wherein the first virtual machine is part of a first group of virtual machines that have a first particular configuration, and the second virtual machine has a second particular configuration that is different than the first particular configuration.

7. The method of claim 3, further comprising selecting to pass the query to the second first virtual machine based on the predicted cost of passing the query to the second virtual machine being lower than the predicted cost of the first virtual machine executing the query.

8. The method of claim 7, further comprising:
determining that the second virtual machine does not currently exist; and
in response to determining that the second virtual machine does not currently exist, causing a computing service to launch the second virtual machine.

9. The method of claim 2, wherein each of the plurality of probabilistic models is associated with an experience set, the method further comprising:
adding to the experience set, for each of the plurality of probabilistic models, a context based on the query and based on a state of that probabilistic model at the first time, an action taken by that probabilistic model in connection with the query, and a cost associated with execution of the query by the first virtual machine.

10. The method of claim 9, wherein the plurality of probabilistic models are organized into hierarchical tiers with virtual machines associated with probabilistic models in a particular tier having a common configuration, and
each of the plurality of probabilistic models is a contextual mutli-armed bandit (CMAB)-based reinforcement learning model that is configured to evaluate which action of a group of actions to select in connection with a particular query, the group of actions including:
accepting the particular query;
passing the particular query to a next probabilistic model in the same tier; and
passing the particular query to a next tier.

11. A system for distributing database queries across a metered virtual network, the system comprising:
at least one hardware processor; and
memory storing instructions that, when executed, cause the at least one hardware processor to:
receive a first query at a first time;
select, using a plurality of probabilistic models, a first virtual machine of a plurality of virtual machines provided via the metered virtual network to execute the first query, wherein each of the plurality of probabilistic models is associated with one of the plurality of virtual machines;
receive information indicative of a monetary cost of executing the first query using the first virtual machine, wherein the cost is based at least in part on the execution time of the first query by the first virtual machine;
provide an observation to each of the plurality of probabilistic models, wherein the observation includes at least information about the cost of executing the first query, and information about an action selected by the probabilistic model in connection with the first query; and
reduce, over time, the costs of using the metered virtual network to execute queries that are received after the first query based on the observations.

12. The system of claim 11, wherein the instructions further cause the at least one hardware processor to:
determine a context based at least in part on the query and based on a state of first virtual machine at the first time; and
provide the context to a first probabilistic model of the plurality of probabilistic models that is associated with the first virtual machine as a feature vector.

13. The system of claim 12, the instructions further cause the at least one hardware processor to:
predict, using the first probabilistic model, the monetary cost of the first virtual machine executing the query based on the context; and
predict, using the first probabilistic model, the monetary cost of passing the query to a second virtual machine of the plurality of virtual machines.

14. The system of claim 13, the instructions further cause the at least one hardware processor to select the first virtual machine to execute the query based on the predicted cost of the first virtual machine executing the query being lower than the predicted cost of passing the query to the second virtual machine.

15. The system of claim 14, wherein the first virtual machine and the second virtual machine are part of a group of virtual machines that have a particular configuration.

16. The system of claim 14, wherein the first virtual machine is part of a first group of virtual machines that have a first particular configuration, and the second virtual machine has a second particular configuration that is different than the first particular configuration.

17. The system of claim 13, the instructions further cause the at least one hardware processor to select to pass the query to the second first virtual machine based on the predicted cost of passing the query to the second virtual machine being lower than the predicted cost of the first virtual machine executing the query.

18. The system of claim 17, the instructions further cause the at least one hardware processor to:
determining that the second virtual machine does not currently exist; and
in response to determining that the second virtual machine does not currently exist, causing a computing service to launch the second virtual machine.

19. The system of claim 12, wherein each of the plurality of probabilistic models is associated with an experience set, the instructions further cause the at least one hardware processor to:
add to the experience set, for each of the plurality of probabilistic models, a context based on the query and based on a state of that probabilistic model at the first time, an action taken by that probabilistic model in connection with the query, and a cost associated with execution of the query by the first virtual machine.

20. The system of claim 19, wherein the plurality of probabilistic models are organized into hierarchical tiers with virtual machines associated with probabilistic models in a particular tier having a common configuration, and
each of the plurality of probabilistic models is a contextual multi-armed bandit (CMAB)-based reinforcement learning model that is configured to evaluate which action of a group of actions to select in connection with a particular query, the group of actions including:
accepting the particular query;
passing the particular query to a next probabilistic model in the same tier; and
passing the particular query to a next tier.

21. A non-transitory computer readable medium containing computer executable instructions that, when executed by a processor, cause the processor to perform a method for distributing database queries across a metered virtual network, the method comprising:
receiving a first query at a first time;
selecting, using a plurality of probabilistic models, a first virtual machine of a plurality of virtual machines provided via the metered virtual network to execute the first query, wherein each of the plurality of probabilistic models is associated with one of the plurality of virtual machines;
receiving information indicative of a monetary cost of executing the first query using the first virtual machine, wherein the cost is based at least in part on the execution time of the first query by the first virtual machine;
providing an observation to each of the plurality of probabilistic models, wherein the observation includes at least information about the cost of executing the first query, and information about an action selected by the probabilistic model in connection with the first query; and
reducing, over time, the costs of using the metered virtual network to execute queries that are received after the first query based on the observations.
